(19) United States
(12) Patent Application Publication
(10) Pub. No.: US 2006/0220798 A1
(43) Pub. Date: Oct. 5, 2006

(54) Medical clinic RFID system

(75) Inventor: Richard A. Willis, Arlington, TN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: APSRFID, LLC

(21) Appl. No.: 11/098,797

(22) Filed: Apr. 5, 2005

(51) Int. Cl. G08B 5/22

(52) U.S. Cl. 340/286.07

(57) ABSTRACT

Disclosed are systems, apparatuses, and methods for tacking and monitoring a patient and provider in a medical clinic. In one embodiment, a system for tracking and monitoring a patient and provider in a medical clinic comprises at least two RF tags, RF readers, and a data acquisition system. The RF tags are attached to a patient and a provider and transmit tag data to the RF readers. The RF readers receive the tag data and associate the tag data to a room, time, date, RF reader ID, etc. The RF readers transmit the tag data and associated data to the data acquisition system via a communication platform. The data acquisition system determines the length of time that the provider took to examine the patient based on the received data from the RF reader.

### TECHNICAL FIELD

The present invention relates to tracking and monitoring systems, and more particularly, the embodiments relate to systems, apparatus, and methods for tracking and monitoring a patient and provider in a medical clinic.

### BACKGROUND OF THE INVENTION

Medical clinics are becoming more aware of client satisfaction and a provider's performance. Nowadays, clinics are scheduling three to four clients in one time slot, e.g., 10 am to 10:30 am, in anticipation that one or two clients will show up on time and the others will either come a little early or a little late. Typically, when a client checks in, the client can wait in a room anywhere from half an hour to over an hour before a provider examines the client. The variation in the waiting period can be attributed to the performance of the provider, depending on how long it takes the provider to examine the patient. If a clinic knows the time a provider usually takes to examine a patient, the clinic can better schedule the clients for appointments, thereby shortening the time the clients have to wait for a provider. Therefore, from the above, it can be appreciated that it would be desirable to have a system, apparatus, and method for tracking a patient and a provider in a medical clinic to provide better customer satisfaction and to evaluate the performance of a provider.

### SUMMARY OF THE INVENTION

Typically, a patient enters a medical clinic and checks in at a front desk. A provider at the front desk activates an RF tag and gives the it to the patient. The RF tag may be clipped to the patient (e.g, clothes) or strapped to the patient (e.g., patient's neck, wrist, or ankle). The provider at the front desk associates the RF tag to the patient via a clinical computer. Providers in the medical clinic are also given RF tags, generally when the provider starts work at the medical clinic. The RF tag is associated to the provider via a clinical computer.

Rooms in the medical clinic can obtain an RF reader that receives the signal from the RF tags and records the time and date that the RF reader receives the signal. As soon as the provider activates the patient's RF tag, the RF reader in the waiting room receives the signal from the RF tag and the signal is time stamped. When a provider calls the patient to a triage room, the RF reader detects that the patient RF tag is no longer in the waiting room, which is time stamped. When the provider takes the patient to the triage room, the RF reader in the triage room receives the signal from the patient tag identifying the patient and associates the time and date that the patient is in the triage room. The RF reader in the triage room also receives data from the provider RF tag when the provider brings the patient into the triage room. The RF reader in the triage room sends the data from the patient and provider RF tags, which are time stamped, to the clinical computer either wirelessly or wired.

After the provider has finished examining the patient, the provider leaves the triage room and the RF reader in the triage room detects that the provider has left the room and sends the data to the clinical computer. The patient can be brought into another room such as a treatment room to be examined by another provider. The RF reader in the treatment room can detect the signal from the patient RF tag and the signal is time stamped. If a provider enters the treatment room, the RF reader detects that the provider is with the patient by receiving data from the provider RF tag. After the provider is done examining the patient, the patient can then be taken to the front desk to be checked out. When both the provider and the patient leave the treatment room, the RF reader in the treatment room detects and time stamps that both the provider and patient have left the treatment room. A provider at the front desk can check the patient out and deactivates the patient RF tag. When the patient checks out of the medical clinic, the provider gathers and confirms the diagnosis and treatment data from the patient RF tag via the clinical computer and transmits the gathered diagnosis and treatment data to a billing system of the medical clinic.

The clinical computer transmits the data from the RF readers to the data acquisition system via a communication platform. In another alternative embodiment, the RF readers can communicate to the data acquisition system via the communication platform; thus bypassing the clinical computer. In both embodiments, the data acquisition system determines the number of patients the provider examines in an hour, day, week, month, and year based on the received data from the RF reader. The data acquisition system can further determine the length of time the provider took to examine the patient, the length of time a patient waits in a room before a provider examines the patient, and the length of time the patient checks in and out of the medical clinic based on the received data from the RF reader.

In an alternative embodiment, the clinical computer can determine the number of patients the provider examines in an hour, day, week, month, and year based on the received data from the RF reader. The clinical computer can further determine the length of time the provider took to examine the patient, the length of time a patient waits in a room before a provider examines the patient, and the length of time the patient checks in and out of the medical clinic based on the received data from the RF reader.

### BRIEF DESCRIPTION OF THE DRAWINGS

The disclosed systems, apparatuses, and methods can be better understood with reference to the following drawings. The components in the drawings are not necessarily to scale.

FIG. 1 is a perspective view of an embodiment of a system to which a patient can be tracked and monitored in a medical clinic.

FIG. 2 is a schematic view of an embodiment of the system shown in FIG. 1.

FIG. 3 is a schematic view of an embodiment of the system shown in FIG. 1.

FIG. 4 is a schematic view of an embodiment of the system shown in FIG. 1.

FIG. 5 is a block diagram of an embodiment of a patient tag of the system shown in FIG. 1.

FIG. 6 is a block diagram of an embodiment of an RF reader of the system shown in FIG. 1.

FIG. 7 is a block diagram of an embodiment of a computing device of the patient tag shown in FIG. 5.

FIG. 8 is a block diagram of an embodiment of a computing device of the RF reader shown in FIG. 6.

FIG. 9 is a block diagram of an embodiment of a clinical computer of the system shown in FIG. 1.

FIG. 10 is a block diagram of an embodiment of a data acquisition system shown in FIG. 1.

FIG. 11 is a flow diagram that illustrates an embodiment of operation of the system shown in FIG. 1 in tracking and monitoring a patient in a medical clinic.

FIG. 12 is a flow diagram that illustrates an embodiment of operation of the system shown in FIG. 1 in tracking and monitoring a patient in the medical clinic.

FIG. 13 is a flow diagram that illustrates an embodiment of operation of a tag manager of a patient tag shown in FIG. 7.

FIG. 14 is a flow diagram that illustrates an embodiment of operation of the RF reader manager of the reader shown in FIG. 1.

FIG. 15 is a flow diagram that illustrates an embodiment of operation of a patient and tag manager of the clinical computer shown in FIG. 1.

FIG. 16 is a flow diagram that illustrates an embodiment of operation of a data acquisition manager of the data acquisition system shown in FIG. 1.

### DETAILED DESCRIPTION OF THE PREFERRED EMBODIMENT

Disclosed herein are systems, apparatuses, and methods to which a patient can be tracked and monitored in a medical clinic. In particular, a patient and a provider are attached with RF tags. The patient is monitored when the patient is checked in until the patient is checked out. The system monitors the patient moving between two rooms, such as a waiting room to a triage room or a treatment room, the time the patient waited in the rooms before the provider examined the patient, the time the provider took to examine the patient, etc. Example systems are first discussed with reference to the figures. Although the systems are described in detail, they are provided for purposes of illustration only and various modifications are feasible. After the exemplary systems have been described, examples of operation of the systems are provided to explain the manner in which the patient can be tracked and monitored in a medical clinic.

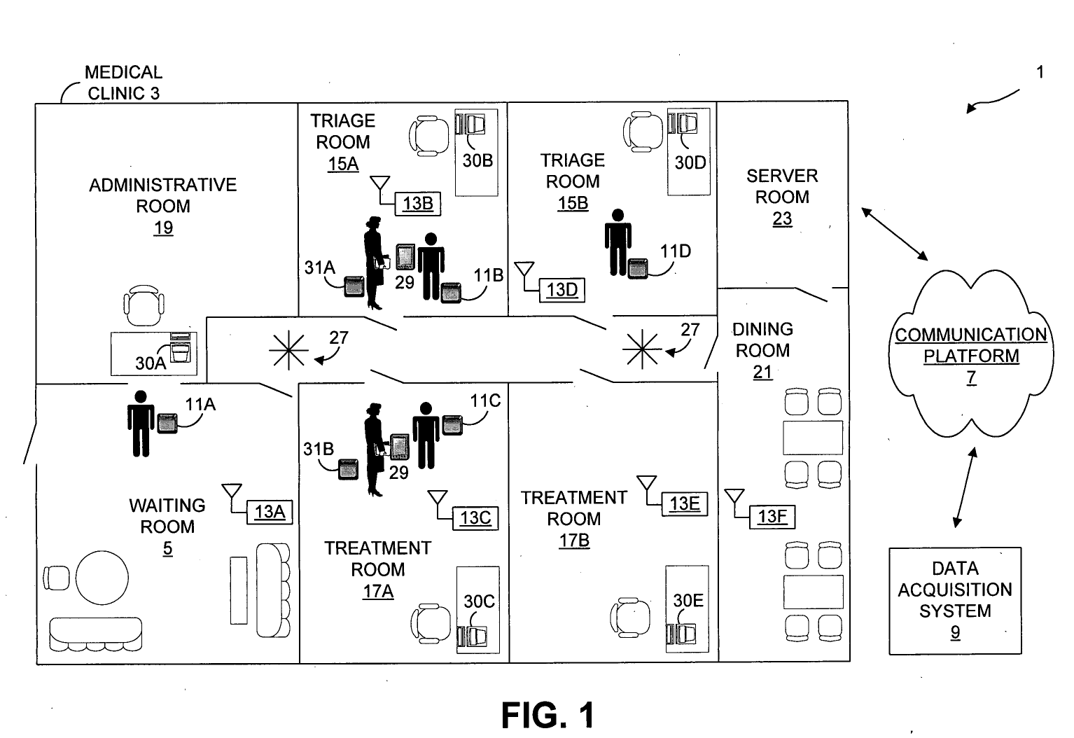

Referring now in more detail to the figures in which like reference numerals identify corresponding parts, FIG. 1 illustrates an exemplary system 1 in which the patient and provider can be tracked and monitored in a medical clinic. The system 1 includes a medical clinic 3, communication platform 7, and data acquisition system 9. The medical clinic 3 includes, but is not limited to, an administrative room 19, waiting room 5, treatment room 17, triage room 15, server room 23, and dining room 21. The administrative room 19, triage 15, and treatment room 17 include clinical computers 30. The waiting room 5, triage room 15, treatment room 17, and dining room 21 include RF reader 13.

A patient is attached with a patient RF tag 11 and a provider is attached with a provider RF tag 31. The provider can be equipped with a personal digital assistant (PDA) 29. The medical clinic 3 can also include a network antenna 27 that receives and transmits data to the RF readers 13. The network antenna 27 is coupled to either the clinical computer 30 or a server in the server room 23 of the medical clinic 3. The RF tags 11, 31 transmit a signal to the RF readers 13, which transmit data to the clinical computer 30. The clinical computer 30 transmits the data from the RF readers to the data acquisition system 9 via the communication platform 7. In another alternative embodiment, the RF reader 13 can communicate to the data acquisition system 9 via the communication platform 7; thus bypassing the clinical computer 30. The data acquisition system 9 determines the number of patients the provider examines in an hour, day, week, month, and year based on the received data from the RF reader 13. The data acquisition system 9 can further determine the length of time the provider took to examine the patient, the length of time a patient waits in a room before a provider examines the patient, and the length of time the patient checks in and out of the medical clinic 3 based on the received data from the RF reader 13.

In an alternative embodiment, the clinical computer 30 can determine the number of patients the provider examines in an hour, day, week, month, and year based on the received data from the RF reader 13. The clinical computer 30 can further determine the length of time the provider took to examine the patient, the length of time a patient waits in a room before a provider examines the patient, and the length of time the patient checks in and out of the medical clinic 3 based on the received data from the RF reader 13. In another alternative embodiment, the RF reader 13 can communicate to the data acquisition system 9 via the communication platform 7. The RF reader 13 bypasses the clinical computer 30.

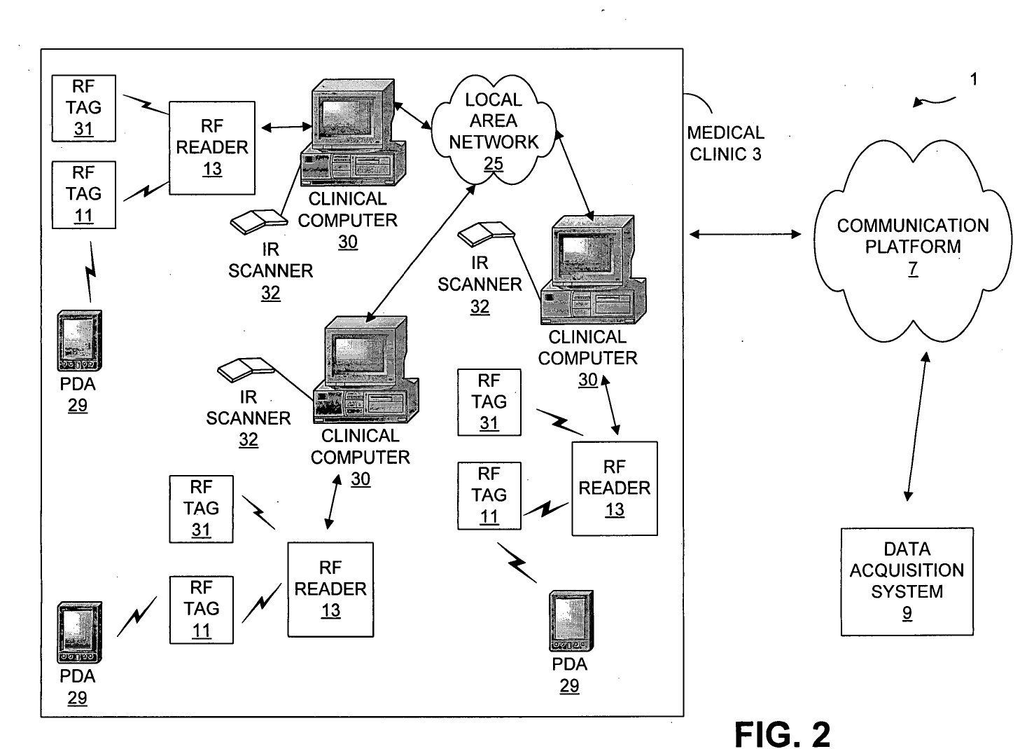

FIG. 2 is a schematic view of an embodiment of the system shown in FIG. 1. The system 1 includes a medical clinic 3 that has at least two clinical computers 30 that communicate to each other via local area network (LAN) 25. The clinical computer 30 is electrically coupled to infrared (IR) scanner 32. The medical clinic 3 further includes RF reader 13 that communicates to the clinical computers 30, either wired or wirelessly. In an alternative embodiment, the RF reader 13 can communicate to the clinical computer 30 via network 25.

The medical clinic 3 further includes RF tag 11 that is attached to a patient and RF tag 31 that is attached to a provider. Both RF tags 11, 31 communicate to the RF readers 13. The provider can further be equipped with a PDA 29 that obtains input from the provider and wirelessly transmits the input to the RF tag 11. The clinical computer 30 can also obtain input from the provider and sends the input to the RF tag 11 via IR scanner 32.

The clinical computer 30 communicates to the data acquisition system 9 via the communication platform 7, which can include a bi-directional satellite communication, Internet protocol communication, cellular communication, public switch telephone network, and short message network communication.

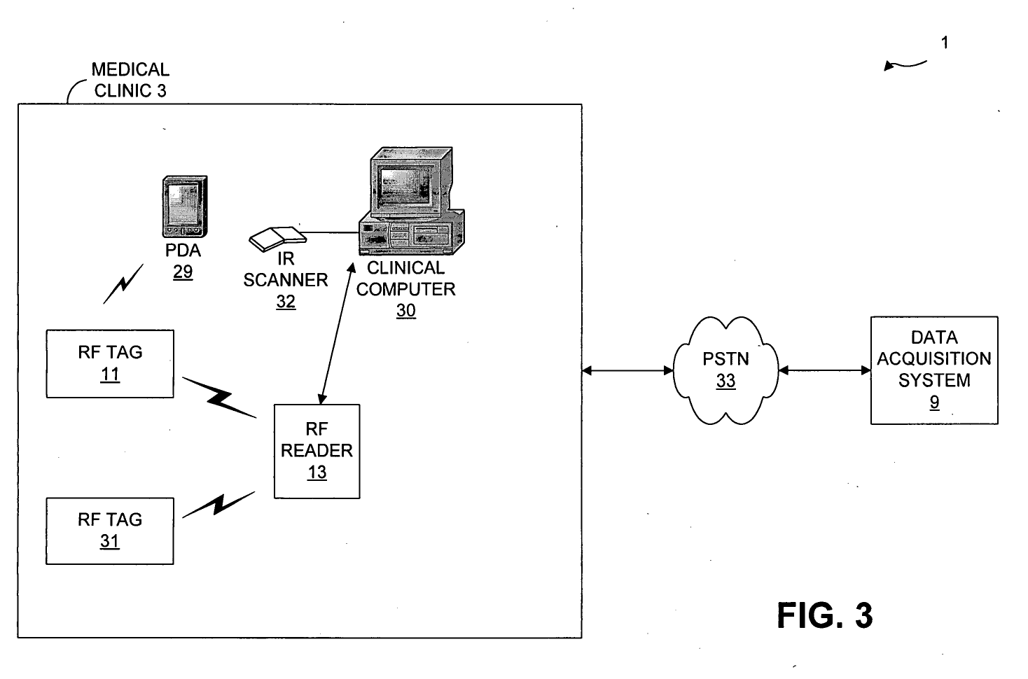

FIG. 3 is a schematic view of an embodiment of the system shown in FIG. 1. The medical clinic 3 includes a clinical computer 30 that communicates to RF reader 13, either wirelessly or wired. The RF reader 13 communicates to the RF tag 11 and RF tag 31 wirelessly. The RF tag 11 can obtain data from the PDA 29 wirelessly. The RF tag 11 can also obtain data from the clinical computer 30 via IR scanner 32. The clinical computer 30 communicates to the data acquisition system 9 via a public switched telephone network (PSTN) 33.

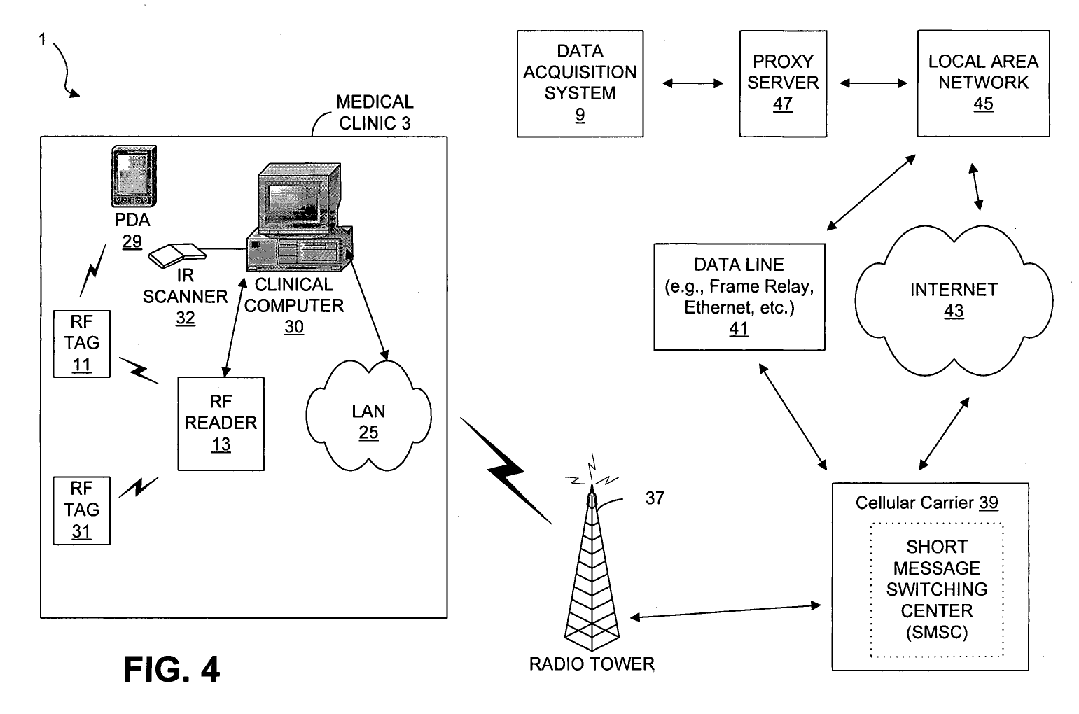

FIG. 4 is a schematic view of an embodiment of the system shown in FIG. 1. FIG. 4 illustrates one embodiment of the communication platform 7 to facilitate communication between the clinical computer 30 and the data acquisition system 9 using radio tower 37, cellular carrier 39, data line 41, Internet 43, local area network 45, and proxy server 47.

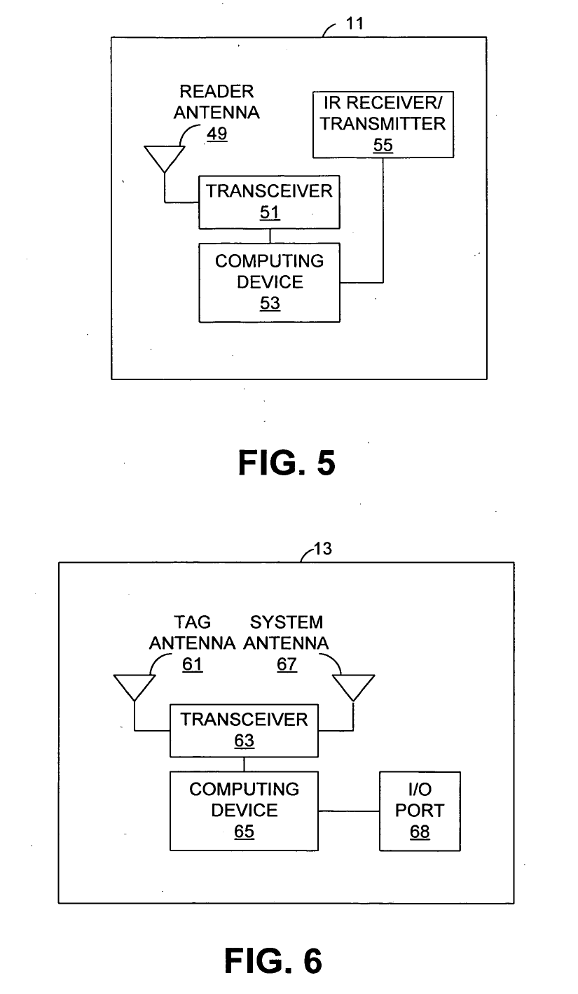

FIG. 5 is a block diagram of an embodiment of the patient RF tag shown in FIG. 1. The RF tag 11 includes a reader antenna 49 that receives and transmits data from and to the RF reader 13. The reader antenna 49 is electrically coupled to transceiver 51, which is electrically coupled to computing device 53. The transceiver 51 receives data from the reader antenna 49 and converts the data from analog to digital format. The transceiver 51 can also receive data from the computing device 53 and converts the data from digital to analog format. The computing device 53 communicates to the RF reader 13 via the transceiver 51 and reader antenna 49. The RF tag 11 further includes an infrared receiver/transmitter 55, which is electrically coupled to the computing device 53. The IR receiver/transmitter 55 receives data from either the PDA 29 or IR scanner 32, and send the data to the computing device 53. The computing device 53 can communicate to the PDA 29 or the clinical computer 30 via the IR receiver/transmitter 55.

It should be noted that the architecture for the provider RF tag 31 is similar to the architecture of the patient RF tag 11 described above and therefore includes a reader, transceiver, computing device and IR receiver/transmitter.

FIG. 6 is a block diagram of the embodiment of the RF reader 13 shown in FIG. 1. The RF reader 13 includes a tag antenna 61, system antenna 67, transceiver 63, computing device 65, and input/output (I/O) port 68. The tag antenna 61 and system antenna 67 are electrically coupled to the transceiver 63, which is electrically coupled to the computing device 65. The I/O port 68 is electrically coupled to the computing device 64. The tag antenna 61 of the RF reader 13 receives and transmits data from and to the patient and provider tags 11, 31. The system antenna 67 receives and transmits data to and from the clinical computer 30. Similar to the transceiver 51 of the patient RF tag 11, the transceiver 63 can convert data from the antennas 61, 67 from analog to digital format, and vice versa from data received from the computing device 65.

The computing device 65 of the RF reader 13 associates the signal to the time, date, RF reader ID, room ID, etc. The computing device 65 communicates the signal from the RF tags 11, 31 and the associated data to the clinical computer 30 via the system antenna 67 or the I/O port 68. The signal from the RF tags and the associated data from the RF readers 13 facilitate tracking and monitoring the patient and provider in the medical clinic 3. It should be noted that the RF reader 13 can communicate to the clinical computer 30 wirelessly or wired via system antenna 67 and I/O port 68, respectively.

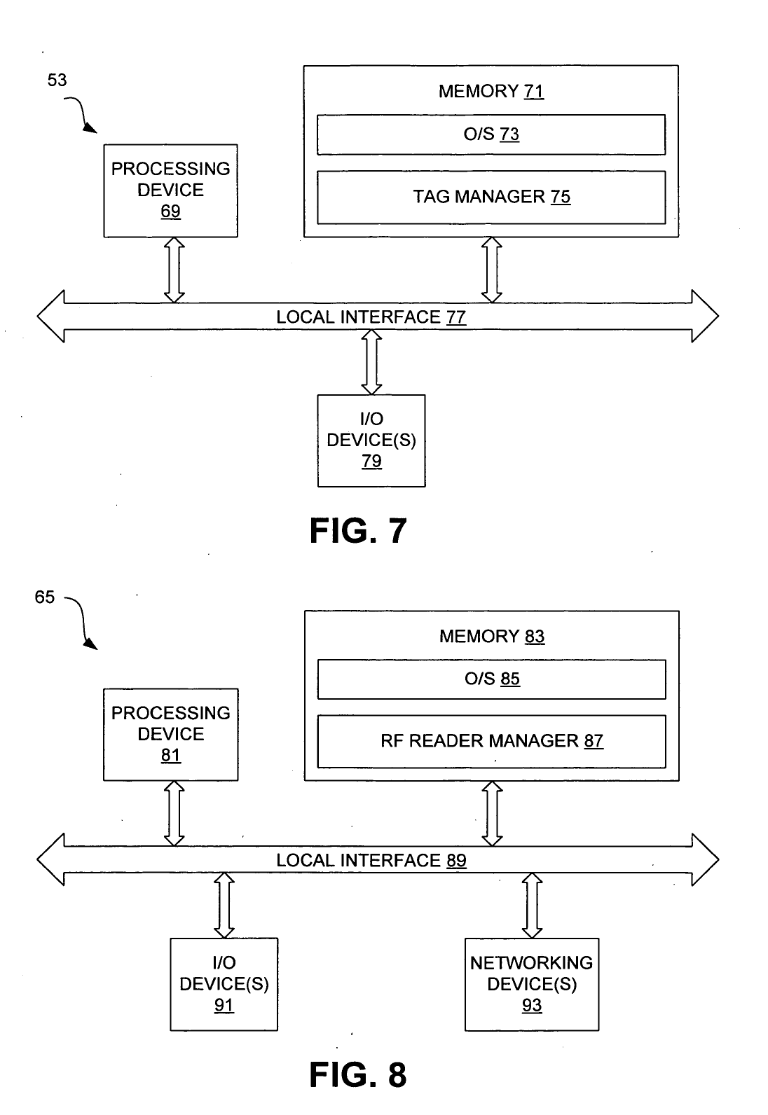

FIG. 7 is a block diagram of an embodiment of a computing device 53 of the patient tag 11 shown in FIG. 5. As indicated in FIG. 7, the computing device 53 comprises a processing device 69, memory 71, and one or more I/O devices 79, each of which is connected to a local interface 77. The processing device 69 can include any custom made or commercially available processor, a central processing unit (CPU) or an auxiliary processor among several processors associated with the computing device 53, a semiconductor based microprocessor (in the form of a microchip), or a macroprocessor. The memory 71 can include any one or a combination of volatile memory elements (e.g., random access memory (RAM, such as DRAM, SRAM, etc.)) and nonvolatile memory elements (e.g., ROM, hard drive, tape, CDROM, etc.).

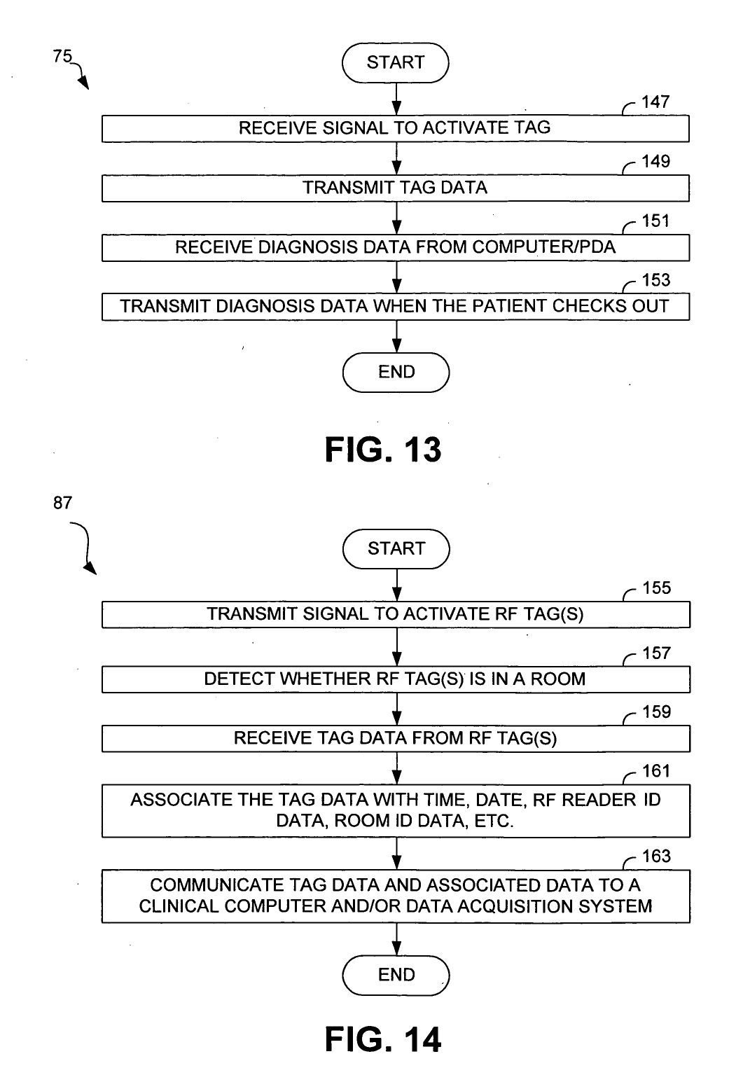

The one or more I/O devices 79 comprise components used to facilitate connection of the computing device 53 to other devices and therefore, for instance, comprise one or more serial, parallel, small system interface (SCSI), universal serial bus (USB), or EEEE 1394 (e.g., Firewire™) connection elements. The memory 71 normally comprises various programs (in software and/or firmware) including an operating system (O/S) 73 and tag manager 75. The O/S 73 controls the execution of programs, including the RF tag manager 75, and provides scheduling, input-output control, file and data management, memory management, and communication control and/or related services. The tag manager 75 facilitates monitoring and tracking of a patient and provider in a medical clinic 3. Typically, the RF tag manager 23 transmits a signal to an RF reader 13, which associates the signal to time, date, RF reader ID, room ID, etc. The tag manager 75 receives diagnosis and treatment data from the provider that can be confirmed when the patient checks out of the medical clinic and can be sent to a billing system of the medical clinic. Operation of the tag manager 75 is described in relation to FIG. 13.

FIG. 8 is a block diagram of an embodiment of a computing device of the RF reader shown in FIG. 6. The architecture for the computing device 65 is similar to the architecture of the computing device 53 of the RF tag 11 described above and therefore includes a processing device 81, and one or more I/O devices 91, each of which is connected to a local interface 89.

The memory.83 in the RF reader 13, however, includes an RF reader manager 87 that facilitates tracking and monitoring a patient and provider in a medical clinic 3. Typically, the RF reader manager 87 receives data from the RF tags 11, 31 and associates the data to time, date, RF reader ID, room ID, and/or location ID, etc. The RF reader manager 87 further transmits the tag data and associated data to facilitate tracking and monitoring the patient and provider in the medical clinic 3. Operation of the RF reader manager 87 is described in relation to FIG. 14.

The architecture for the computing device 65 of the RF reader 13 further includes networking devices 93. The networking devices 93 comprise the various components used to transmit and/or receive data over the communication platform 7, where provided. By way of example, the networking devices 93 include a device that can communicate both inputs and outputs, for instance, a modulator/demodulator (e.g., modem), a radio frequency (RF) or infrared (IR) transceiver, a telephonic interface, a bridge, a router, as well as a network card, etc.

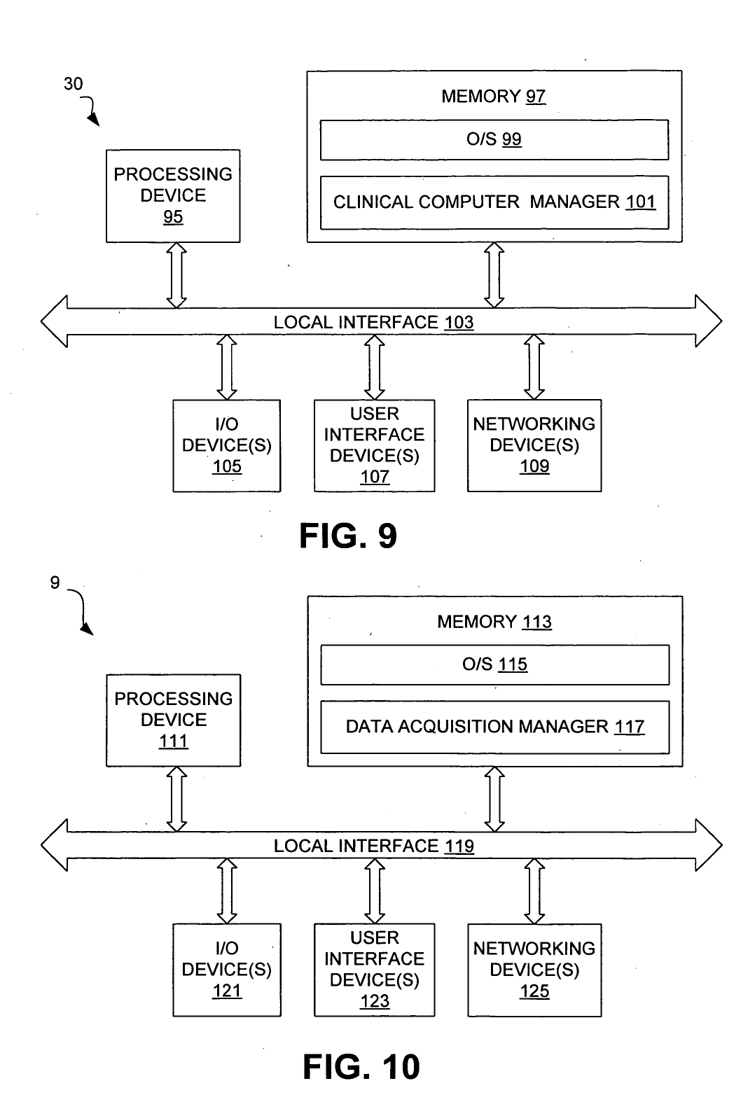

FIG. 9 is a block diagram of an embodiment of a clinical computer of the system shown in FIG. 1. The architecture for the clinical computer 30 is similar to the architecture of the computing device 65 of the RF reader 13 described above and therefore includes a processing device 95, one or more networking devices 109, and one or more I/O devices 105, each of which is connected to a local interface 103.

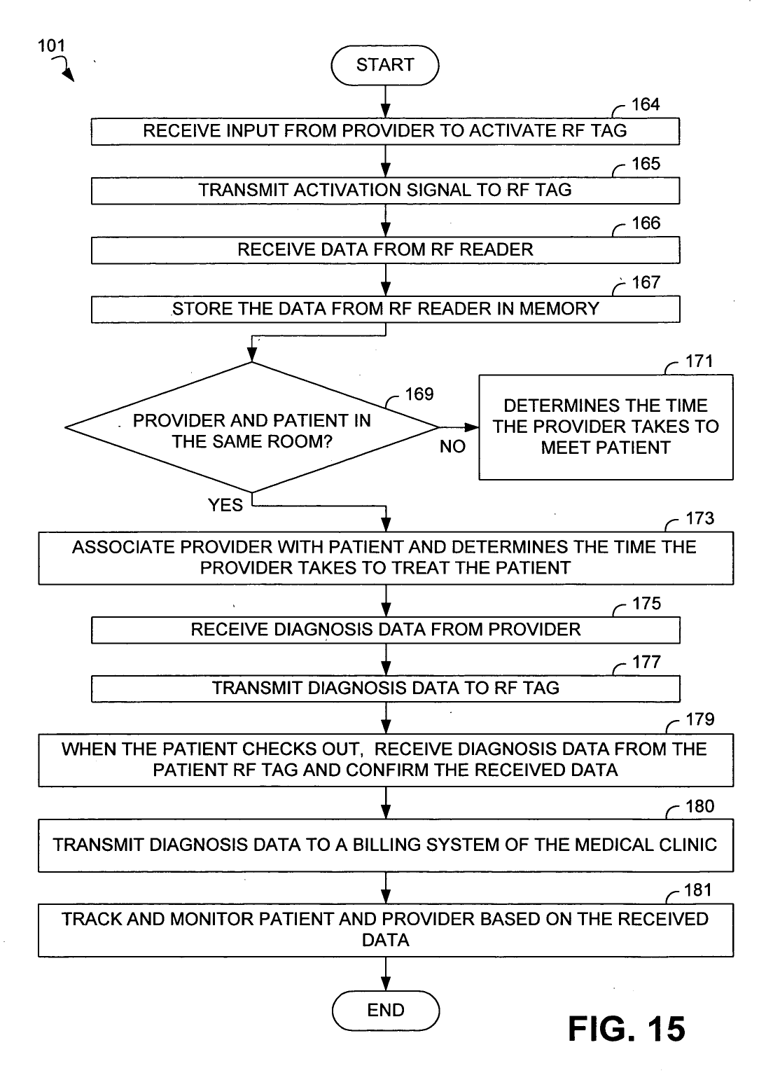

The memory 97 in the clinical computer 30, however, includes a clinical computer manager 101 that facilitates tracking and monitoring the patient and provider in the medical clinic 3. Typically, the clinical computer manager 101 receives data from the RF reader and uses the data to track and monitor the patient and provider in the medical clinic 3. Operation of the RF reader manager 87 is described in relation to FIG. 15.

The architecture for the clinical computer 30 further includes one or more user interface devices 107. The one or more user interface devices 101 comprise those components with which the user (e.g., administrator) can interact with the clinical computer 30. Where the clinical computer 30 comprises a server computer or similar device, these components can comprise those typically used in conjunction with a PC such as a keyboard and mouse.

FIG. 10 is a block diagram of an embodiment of a data acquisition system shown in FIG. 1. The architecture for the data acquisition system 9 is similar to the architecture of the clinical computer 30 described above and therefore includes a processing device 111, one or more user interface devices 123, one or more networking devices 125, and one or more I/O devices 121, each of which is connected to a local interface 119.

The memory 113 in the data acquisition system 9, however, includes a data acquisition manager 117 that facilitates tracking and monitoring the patient and provider in the medical clinic 3. Typically, the clinical computer manager 101 receives data from the RF reader and uses the data to track and monitor the patient and provider in the medical clinic 3. Operation of the RF reader manager 87 is described in relation to FIG. 17

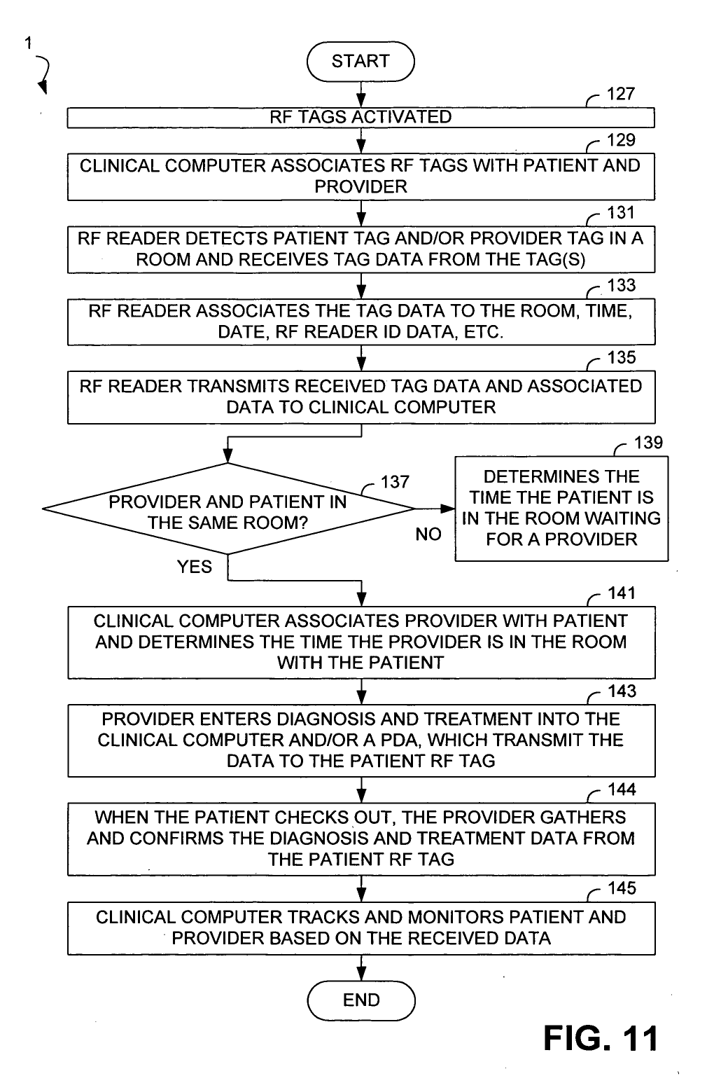

FIG. 11 is a flow diagram that illustrates an embodiment of operation of the system shown in FIG. 1 in tracking and monitoring a patient and provider in a medical clinic 3. Beginning with block 127, RF tags are activated for both provider and patient. For example, the provider RF tag 31 is activated when the provider checks in for work at the medical clinic 3. The patient RF tag 11I is activated when the patient checks for an examination in the medical clinic 3. The RF tags 11, 31 are associated to the patient and provider via a clinical computer 30, as indicated in block 129. The RF tag 11 is associated to a patient when the patient checks into the medical clinic 3. The RF tag 11 can be re-used after the patient checks out of the medical clinic 3 for another patient.

After the RF tag is activated and associated with a patient or a provider, an RF reader 13 detects the patient and/or provider in a room by receiving data from the patient RF tag 11 and provider RF tag 31, as shown in block 131. The RF reader 13 associates the tag data to the room, time, date, RF reader ID data, etc., as shown in block 133. The RF reader 13 transmits the received tag data and associated data to the clinical computer 30, as shown in block 135. In an alternative embodiment, the RF reader 13 can transmit the received tag data and associated data to a data acquisition system 9 via a communication platform 7, which bypasses the clinical computer 30.

In block 137, the clinical computer 30,determines whether the provider and patient are in the same room by comparing the tag data and associated data. For example, if the patient is in the triage room 15B (FIG. 1) and the provider is not, the RF reader 13D receives data from the patient RF tag and not the provider RF tag. The RF reader 13D associates the data from the patient RF tag to the room, time, data, RF reader ID, etc. The RF reader 13D transmits the tag data and the associated data to the clinical computer 30. The clinical computer 30 determines that the patient is in the triage room 15B and no provider is in there at a particular time and date based on the data from the RF reader 13D.

If the provider and the patient are in the same room, e.g., triage room 1 5A (FIG. 1), the RF reader 13B receives data from both the provider RF tag and patient RF tag. The RF reader 13B associates the data from the tags to the room, time, data, and RF reader ID, etc. The RF reader 13B transmits the patient tag data and provider tag data along with the associated data to the clinical computer 30, which determines that the patient and the provider are in the triage room 15A at a particular time and date based on the data from the RF reader 13B.

If the clinical computer 30 determines that the provider and the patient are not in the same room, the clinical computer 30 determines the time the patient was in a room waiting for a provider, as indicated in block 139. If the clinical computer 30 determines that the provider and the patient are in the same room, the clinical computer 30 associates the provider with the patient and determines the time that the provider is in the room with the patient, as indicated in block 141. The approximate time that the provider takes to examine the patient can also be determined from the time the provider is in the room with the patient.

In block 143, the provider enters a diagnosis and treatment for the patient into the clinical computer 30 and/or a PDA 29, which transmit the data to the patient RF tag 11. The clinical computer 30 transmits the data to the patient RF tag 11 via an IR scanner 32 and the PDA 29 transmits the data via IR receiver/transmitter 55. In block 145, when the patient checks out of the medical clinic 3, the provider gathers and confirms the diagnosis and treatment data from the patient RF tag 11 via the clinical computer 30 and transmits the gathered diagnosis and treatment data to a billing system of the medical clinic 3, as indicated in block 144. The clinical computer 30 tracks and monitors the patient and provider in the medical clinic 3 based on the received data from the RF reader 13, as indicated in block 145. For example, the clinical computer 30 determines the number of patients the provider examines in an hour, day, week, month, and year based on the received data from the RF reader. The clinical computer 30 can further determine the length of time the provider took to examine the patient, the length of time a patient waits in a room before a provider examines the patient, and the length of time the patient checks in and out of the medical clinic based on the received data from the RF reader.

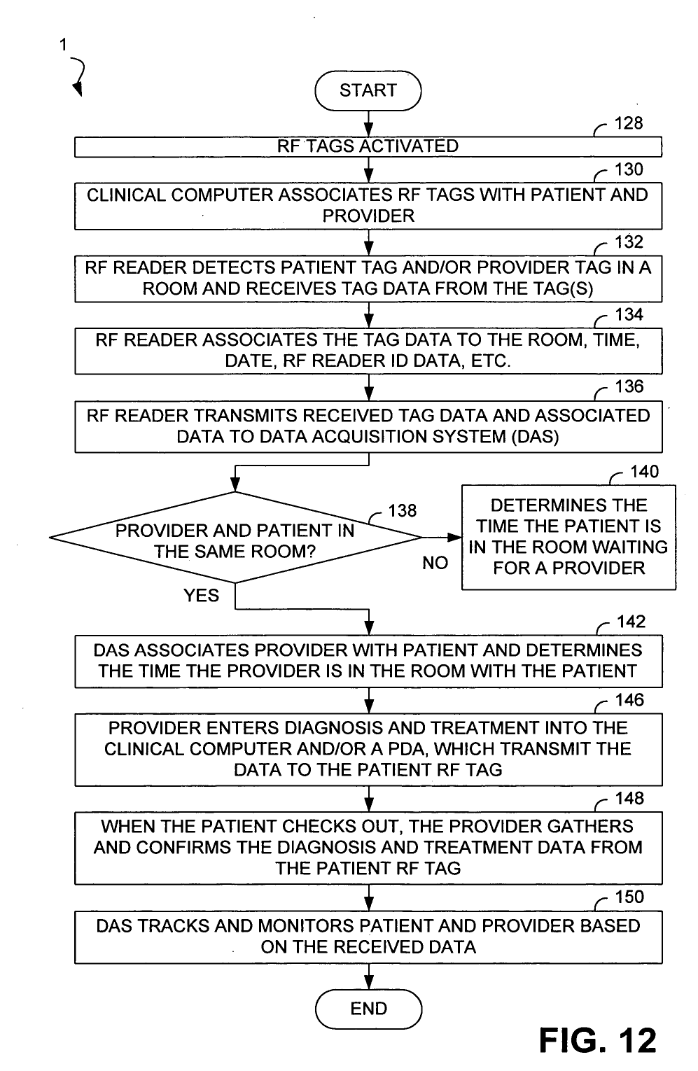

FIG. 12 is a flow diagram that illustrates an embodiment of operation of the system shown in FIG. 1 in tracking and monitoring a patient in a medical clinic 3. Beginning with block 128, RF tags are activated for both provider and patient. The RF tags 11, 31 are associated to the patient and provider via a data acquisition system 9, as indicated in block 130. After the RF tag is activated and associated with a patient or a provider, an RF reader 13 detects the patient and/or provider in a room by receiving data from the patient RF tag 11 and provider RF tag 31, as shown in block 132. The RF reader 13 associates the tag data to the room, time, date, RF reader ID data, etc., as shown in block 134. The RF reader 13 transmits the received tag data and associated data to the data acquisition system 9, as shown in block 136.

In block 138, the data acquisition system 9 determines whether the provider and patient are in the same room by comparing the tag data and associated data. For example, if the patient is in the triage room 15B (FIG. 1) and the provider is not, the RF reader 13D receives data the patient RF tag 11 and not the provider RF tag 31. The RF reader 13D associates the data from the patient RF tag 11 to the room, time, data, RF reader ID, etc. The RF reader 13D transmits the tag data and the associated data to the data acquisition system 9. The data acquisition system 9 determines that the patient is in the triage room 15B and no provider is in there at a particular time and date based on the data from the RF reader 13D.

If the provider and the patient are in the same room, e.g., triage room 15A (FIG. 1), the RF reader 13B receives data from both the provider RF tag 31 and patient RF tag 11. The RF reader 13B associates the data from the tags to the room, time, data, and RF reader ID, etc. The RF reader 13B transmits the patient tag data and provider tag data along with the associated data to the data acquisition system 9, which determines that the patient and the provider are in the triage room 15A at a particular time and date based on the data from the RF reader 13B.

If the data acquisition system 9 determines that the provider and the patient are not in the same room, the data acquisition system 9 determines the time the patient was in a room waiting for a provider, as indicated in block 140. If the data acquisition system 9 determines that the provider and the patient are in the same room, the data acquisition system 9 associates the provider with the patient and determines the time that the provider is in the room with the patient, as indicated in block 142. The approximate time that the provider takes to examine the patient can also be determined from the time the provider is in the room with the patient.

In block 146, the provider enters a diagnosis and treatment for the patient into a clinical computer 30 and/or a PDA 29, which transmit the data to the patient RF tag 11. The clinical computer 30 transmits the data to the patient RF tag 11 via an IR scanner 32 and the PDA 29 transmits the data via IR receiver/transmitter 55. In block 148, when the patient checks out of the medical clinic 3, the provider gathers and confirms the diagnosis and treatment data from the patient RF tag 11 via the clinical computer 30 and transmits the gathered diagnosis and treatment data to a billing system of the medical clinic 3, as indicated in block 148. The data acquisition system 9 tracks and monitors the patient and provider in the medical clinic 3 based on the received data from the RF reader 13, as indicated in block 150. For example, the data acquisition system 9 determines the number of patients the provider examines in an hour, day, week, month, and year based on the received data from the RF reader. The data acquisition system 9 can further determine the length of time the provider took to examine the patient, the length of time a patient waits in a room before a provider examines the patient, and the length of time it takes the patient checks in and out of the medical clinic based on the received data from the RF reader 13.

FIG. 13 is a flow diagram that illustrates an embodiment operation of the tag manager 75 of the patient RF tag 11 shown in FIG. 7. Beginning with block 147, the tag manager 75 receives a signal to activate the tag. For example, the provider can activate the patient RF tag 11 via the clinical computer 30, which sends the activating signal to the RF reader 13 and in turn the RF reader 13 communicates to the patient RF tag 11 to activate the tag. After the tag is activated, the tag manager 75 enables the tag 1I to transmit tag data, as indicated in block 149. The tag manager 75 receives diagnosis and treatment data from either the clinical computer 30 and/or PDA 29, as indicated in block 151. When the patient checks out of the medical clinic 3, the provider deactivates the patient RF tag 11 via the clinical computer 30. When the clinical computer 30 deactivates the RF tag 11, the tag manager 75 transmits diagnosis and treatment data for the clinical computer 30 to confirm that the diagnosis data is consistent with the data in the clinical computer 30 and the tag manager 75 deactivates the patient RF tag 11, as indicated in block 153.

It should be noted that, with regard to the provider tag 31, the clinical computer activates and deactivates the provider tag 31 when the provider begins and ends work at the medical clinic 3. The provider tag 31 transmits tag data to the RF reader 13 to track and monitor the provider in the medical clinic 3.

FIG. 14 is a flow diagram that illustrates an embodiment operation of the RF reader manager 87 of the RF reader 13 shown in FIG. 1. Beginning with block 155, the RF reader manager 87 receives an activation signal from the clinical computer 30 and transmits an activation signal to the RF tags 11, 31. The RF reader manager 87 detects whether RF tags 11, 31 are in a room, as indicated in block 157. The RF reader manager 87 receives tag data from the RF tags, as indicated in block 159, and associates the tag data with the time, date, RF reader ID data, room ID data, etc., as indicated in block 161. The RF reader manager 87 further communicates the data and associated data to a clinical computer 30 and/or a data acquisition system 9.

FIG. 15 is a flow diagram that illustrates an embodiment of operation of the clinical computer manager 101 of the clinical computer 30 shown in FIG. 1. Beginning with block 164, the clinical computer manager 101 receives input from the provider to active RF tags 11, 31. In block 165, the clinical computer manager 101 enables the clinical computer 30 to transmit activation signal to the RF tags 11, 31. The clinical computer manager 101, in block 166, receives the data from the RF reader 1 and stores the data in memory 97, as indicated in block 167.

In block 169, the clinical computer manager 101 determines whether the provider and patient are in the same room by comparing the data from the RF reader 13. If the clinical computer manager 101 determines that the provider and the patient are not in the same room, the clinical computer manager 101 determines the time the provider takes to meet the patient, as indicated in block 171. If the clinical computer manager 101 determines that the provider and the patient are in the same room, the clinical computer manager 101 associates the provider with the patient and determines the time that the provider takes to treat the patient, as indicated in block 173.

In block 175, the clinical computer manager 101 receives a diagnosis and treatment for the patient. The clinical computer manager 101 transmits the data to the patient RF tag 11, as indicated in block 177. When the patient checks out of the medical clinic 3, the clinical computer manager 101 gathers and confirms the diagnosis and treatment data from the patient RF tag 11, as indicated in block 144. The clinical computer manager 101 can further transmit the gathered diagnosis and treatment data to a billing system of the medical clinic 3, as indicated in block 180. The clinical computer manager 101 tracks and monitors the patient and provider in the medical clinic 3 based on the received data from the RF reader 13, as indicated in block 181.

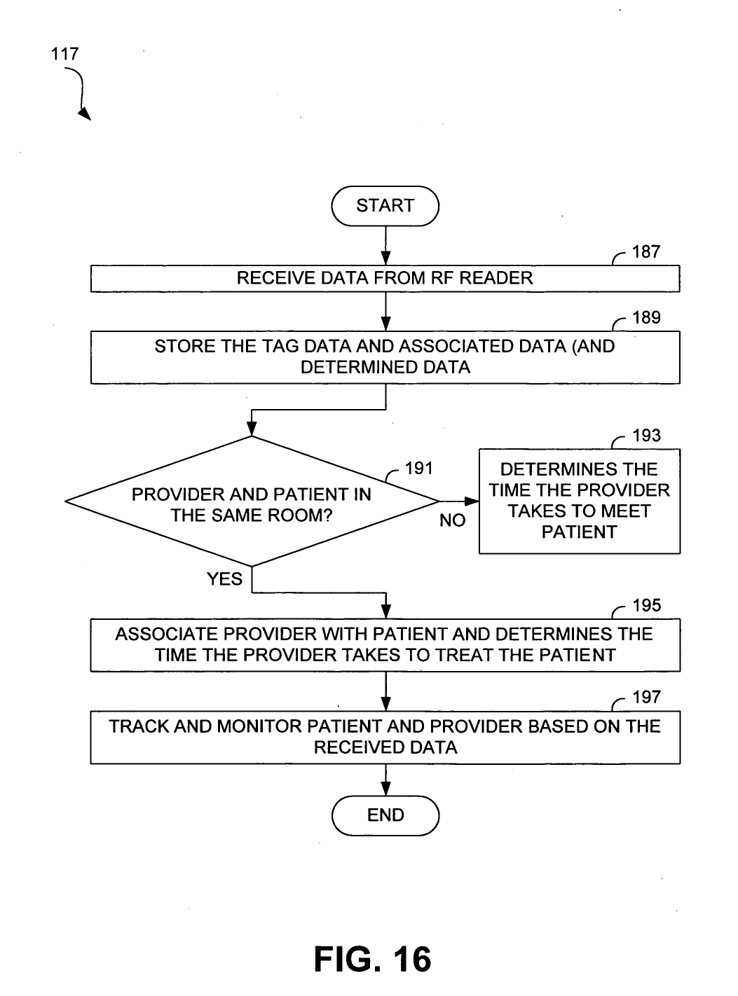

FIG. 16 is a flow diagram that illustrates an embodiment of operation of a data acquisition manager of the data acquisition system shown in FIG. 1. Beginning with block 187, the data acquisition manager 117 receives the data from the RF reader 1 and stores the data in memory 113, as indicated in block 189. In block 191, the data acquisition manager 117 determines whether the provider and patient are in the same room by comparing the data from the RF reader 13. If the data acquisition manager 117 determines that the provider and the patient are not in the same room, the data acquisition manager 117 determines the time the provider takes to meet the patient, as indicated in block 193.

If the data acquisition manager 117 determines that the provider and the patient are in the same room, the data acquisition manager 117 associates the provider with the patient and determines the time that the provider takes to treat the patient, as indicated in block 195. In block 197, the data acquisition manager 117 tracks and monitors the patient and provider in the medical clinic 3 based on the received data from the RF reader 13.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A system for tracking and monitoring a patient and provider in a medical clinic, the system comprising:
at least two RF tags that are attached to a patient and a provider, and are capable of transmitting tag data; and
an RF reader that receives the tag data from the RF tags and transmits the tag data; and
a data acquisition system that receives the data from the RF reader via a communication platform and determines the length of time that the provider took to examine the patient based on the received data from the RF reader.

2. The system of claim 1, wherein the RF tag is passive that is triggered by the RF reader to transmit the tag data.

3. The system of claim 1, wherein the RF tag is active that transmits tag data.

4. The system of claim 1, further comprising a clinical computer located in the medical clinic, wherein the RF reader is placed in a room, the RF reader being capable of associating the tag data to one of a provider, patient, room, time, and date, and transmitting the data to the clinical computer.

5. The system of claim 1, wherein the RF reader is placed in a room, the RF reader being capable of associating the tag data to one of a provider, patient, room, time, and date, and transmitting the data to the data acquisition system located in a remote location via the communication platform.

6. The system of claim 1, wherein the RF reader activates the RF tag to transmit the tag data.

7. The system of claim 1, wherein the communication platform is one of bi-directional satellite communication, Internet protocol communication, cellular communication, public switched telephone network, and short message network communication.

8. The system of claim 1, wherein the data acquisition system determines the number of patients the provider examines in an hour, day, week, month, and year based on the received data from the RF reader, and
wherein the data acquisition system determines the length of time a patient waits in a room before a provider examines the patient and the length of time it takes the patient checks in and out of the medical clinic based on the received data from the RF reader.

9. The system of claim 1, further comprising a clinical computer that receives data from the RF reader and transmits the data to the data acquisition system via the communication platform.

10. The system of claim 9, wherein the clinical computer determines the number of patients the provider examines in an hour, day, week, month, and year based on the received data from the RF reader, and
wherein the clinical computer determines the length of time a patient waits in a room before a provider examines the patient and the length of time the patient checks into and out of the medical clinic based on the received data from the RF reader.

11. The system of claim 1, further comprising a personal digit assistant (PDA) that receives diagnosis and treatment data from the provider and transmits the data to the patient RF tag.

12. The system of claim 1, further comprising a clinical computer that receives diagnosis and treatment data from the provider and transmits the data to the patient RF tag.

13. A system for tracking and monitoring a patient and provider in a medical clinic, the system comprising:
at least two RF tags that are attached to a patient and a provider, and are capable of transmitting tag data; and
an RF reader that receives the tag data from the RF tags and transmits the tag data; and
a clinical computer that receives the data from the RF reader and determines the length of time that the provider took to examine the patient based on the received data from the RF reader.

14. The system of claim 13, wherein the RF tag is passive that is triggered by the RF reader to transmit the tag data.

15. The system of claim 13, wherein the RF tag is active that transmits tag data.

16. The system of claim 13, wherein the RF reader activates the RF tag to transmit the tag data.

17. The system of claim 13, wherein the RF reader is placed in a room, the RF reader being capable of associating the tag data to one of a provider, patient, room, time, and date, and transmitting the data to the clinical computer located in the medical clinic.

18. The system of claim 17, further comprising a data acquisition system located in a remote location, wherein the clinical computer transmits the data from the RF reader to the data acquisition system via a communication platform.

19. The system of claim 18, wherein the communication platform is one of bi-directional satellite communication, Internet protocol communication, cellular communication, public switched telephone network, and short message network communication.

20. The system of claim 17, wherein the data acquisition system determines the number of patients the provider examines in an hour, day, week, month, and year based on the received data from the clinical computer, and
wherein the data acquisition system determines the length of time a patient waits in a room before a provider examines the patient and the length of time it takes the patient checks in and out of the medical clinic based on the received data from the clinical computer.

21. The system of claim 13, further comprising a personal digit assistant (PDA) that receives diagnosis and treatment data from the provider and transmits the data to the patient RF tag.

22. The system of claim 13, wherein the clinical computer receives diagnosis and treatment data from the provider and transmits the data to the patient RF tag.

23. A data acquisition system that facilitates tracking and monitoring a patient and provider in a medical clinic, the data acquisition system comprising:
a processing device; and
a memory having an operating system and a data acquisition manager, the processing device interacting with the memory to facilitate the operating system in controlling the execution of at least the data acquisition manager,
wherein the data acquisition manager stored in a computer-readable medium, the manager comprising:
logic configured to receive data from an RF reader and;
logic configured to determine the length of time that the provider took to examine the patient based on the received data.

24. The data acquisition system of claim 23, wherein the data acquisition manager further comprises logic configured to determine the number of patients the provider examines in an hour, day, week, month, and year based on the received data from the RF reader.

25. The data acquisition system of claim 23, wherein the data acquisition manager further comprises logic configured to determine the length of time a patient waits in a room before a provider examines the patient and the length of time it takes the patient checks in and out of the medical clinic based on the received data from the RF reader.

26. A clinical computer that facilitates tracking and monitoring a patient and provider in a medical clinic, the clinical computer comprising:
a processing device; and
a memory having an operating system and a clinical computer manager, the processing device interacting with the memory to facilitate the operating system in controlling the execution of at least the clinical computer manager,
wherein the clinical computer manager stored in a computer-readable medium, the manager comprising:
logic configured to receive data from an RF reader; and logic configured to determine the length of time that the provider took to examine the patient based on the received data based on the received data from the RF reader.

27. The clinical computer of claim 26, wherein the clinical computer manager further comprises logic configured to associate the tag data to one of a provider, patient, room, time, and date.

28. The clinical computer of claim 27, wherein the clinical computer manager further comprises logic configured to determine the number of patients the provider examines in an hour, day, week, month, and year based on the received data from the RF reader.

29. The clinical computer of claim 27, wherein the clinical computer manager further comprises logic configured to determine the length of time a patient waits in a room before a provider examines the patient and the length of time the patient checks in and out of the medical clinic based on the received data from the RF reader.

30. The clinical computer of claim 26, wherein the clinical computer manager further comprises logic configured to receive diagnosis and treatment data from the provider and transmit the data to an RF tag attached to a patient.

31. A method for tracking and monitoring a patient and provider in a medical clinic, the method comprising:
transmitting tag data from the RF tag;
receiving the tag data via an RF reader located in a room of a medical clinic;
associating the tag data to one of a provider and patient; and
determining the length of time that the provider took to examine the patient based on the received data and associated data;

32. The method of claim 30, further comprising associating the tag data to one of time, date, and room.

33. The method of claim 30, further comprising activating the RF tag to transmit the tag data.

34. The method of claim 30, further comprising determining the number of patients the provider examines in an hour, day, week, month, and year based on the tag data and associated data.

35. The method of claim 30, further comprising determine the length of time a patient waits in a room before a provider examines the patient based on the tag data and associated data.

36. The method of claim 30, further comprising determining the length of time the patient checks in and out of the medical clinic based on the tag data and associated data.
